(19) United States
(12) Patent Application Publication
(10) Pub. No.: US 2015/0246418 A1
(43) Pub. Date: Sep. 3, 2015

(54) Anti-Spatter Composition

(71) Applicant: Barnes Group Inc., Bristol, CT (US)

(72) Inventors: Gigi P. Streeter, Okemos, MI (US); Michael G. Palmiter, Portland, MI (US); James M. Noe, Lansing, MI (US)

(73) Assignee: BARNES GROUP INC.

(21) Appl. No.: 14/713,189

(22) Filed: May 15, 2015

Related U.S. Application Data
(62) Division of application No. 13/710,881, filed on Dec. 11, 2012.
(60) Provisional application No. 61/570,023, filed on Dec. 13, 2011.

(51) Int. Cl. B23K 35/22; B23K 26/40; B23K 26/14; B23K 26/38

(52) U.S. Cl. CPC B23K 35/228; B23K 26/38; B23K 26/401; B23K 26/14

(57) ABSTRACT

An anti-spatter composition for use with the laser cutting of titanium or titanium containing materials. The anti-spatter composition includes Lecithin and one or more organic solvents. The one or more organic solvents are absent halogen and halogen containing compound. The anti-spatter composition can also include surfactant and water. The surfactant is generally halogen free.

The present invention is a divisional of U.S. patent application Ser. No. 13/710,881 filed Dec. 11, 2012, which in turn claims priority on U.S. Provisional Application Ser. No. 61/570,023 filed Dec. 13, 2011, which is incorporated herein by reference.

The present invention is directed to a composition that reduces spatter during the cutting of metals; more particularly to a composition that reduces spatter during the laser cutting of metals; even more particularly to a composition that reduces spatter during the laser cutting of metals, which composition can be easily applied to a metal surface, which composition remains on the metal surface, and which can be easily cleaned from the cut metal surface; still even more particularly to a non-halogen compound containing composition that reduces spatter during the laser cutting of metals, which composition can be easily applied to a metal surface, which composition remains on the metal surface, and which composition can be easily cleaned from the cut metal surface; and yet even more particularly to a non-halogen compound containing composition that reduces spatter during the laser cutting of titanium containing materials, which non-halogen compound containing composition can be easily applied to the surface of titanium containing materials prior to and during the cutting of the titanium containing materials, and which non-halogen compound containing composition can be easily cleaned from the cut titanium containing materials.

### SUMMARY OF THE INVENTION

The anti-spatter composition of the present invention was developed to provide a non-halogenated product for laser cutting titanium and titanium alloys. As can be appreciated, the anti-spatter composition of the present invention can also be used for cutting materials other than titanium and titanium alloys. One non-limiting feature of the anti-spatter composition of the present invention is that the composition is absent halogen containing compounds, and in particular fluorine, chlorine and bromine containing compounds. Currently, many consumers and users of titanium materials prohibit the use of chlorine compounds (and compounds containing chlorides) on the titanium materials when the titanium materials are cut. While there are other anti-spatter products on the market that do not contain chlorine containing compounds, bromine containing compounds and fluorine containing compound, such prior art products do not work well in terms of keeping spatter from re-solidifying to the titanium materials after the titanium materials have been cut by a laser. The anti-spatter composition of the present invention overcomes the past problems associated with prior art anti-spatter agents. The anti-spatter composition of the present invention 1) is absent or substantially absent any halogen compounds, 2) reduces spatter during the laser cutting of titanium containing materials, 3) can be easily applied to the surface of titanium containing materials, 4) remains on the titanium containing materials prior to and during the laser cutting process, 5) is easy to clean from the cut titanium containing materials, and/or 6) inhibits or prevents spatter from re-solidifying on the cut titanium containing materials.

The anti-spatter composition of the present invention is better and more effective than other prior art non-halogenated anti-spatter compositions since the anti-spatter composition of the present invention has good adhesion to the metal part to be cut. The application of the anti-spatter composition of the present invention to a metal surface does not result in excessive run off (i.e., product dripping off the metal part), and yields excellent results in the prevention of spatter re-solidifying to the cut titanium containing material. The prevention of spatter re-solidifying on the cut titanium containing material can drastically reduce the post processing time that would normally be necessary to manually remove the spatter that would have been allowed to re-solidify to the cut titanium containing material.

The anti-spatter composition of the present invention includes an organic solvent that does not contain halogen or halogen compounds. The organic solvent that does not contain halogen or halogen compounds generally includes C2-C20 alcohols, acetone, white spirits, Stoddard solvent, C2-C20 alkanes, C2-C20 alkenes, and/or C2-C20 aromatics. As can be appreciated, other or additional organic solvent that does not contain halogen or halogen compounds can be used. In one non-limiting formulation, the organic solvent that does not contain halogen or halogen compounds is or includes Isopropyl Alcohol.

The anti-spatter composition of the present invention also includes Lecithin. The volume or weight ratio of Lecithin to organic solvent is generally 1:0.01-99, typically 1:0.1-90, more typically 1:0.5-50, still more typically 1:1.01-20, yet more typically 1:1.01-15, still yet more typically 1:2-10, still more typically 1:4-8, and further more typically 1:6-8. In one non-limiting embodiment, the volume or weight percent of Lecithin is less than the volume or weight percent of organic solvent in the anti-spatter composition.

The anti-spatter composition can optionally include water and a surfactant. Generally, the water and surfactant are absent or substantially absent halogens. The water is generally deionized water so as to eliminate the introduction of halogens and other impurities into the anti-spatter composition; however, this is not required. The surfactant is also generally halogen free so as to eliminate the introduction of halogens into the anti-spatter composition. The one or more surfactants, when used, can be used to improve emulsification and maintain the breakdown of Lecithin particles in the anti-spatter composition and/or to increase the dispersion forces in the

Lecithin and thereby minimize the need for continual agitation prior to use of the anti-spatter composition; however, this is not required. Non-limiting surfactants that can be used include trisodium phosphate (TSP) and/or TSP substitutes (i.e., phosphate free surfactant). Non-limiting examples of TSP substitutes include sodium xylenesulfonate and sodium metasilicate. When water and surfactant are included in the anti-spatter composition, the amount of water is generally greater than the Lecithin and/or surfactant content in the anti-spatter composition; however, it can be appreciated that the Lecithin content can be greater than the water content. Also, when water and surfactant are included in the anti-spatter composition, the amount of Lecithin is generally greater than the surfactant content in the anti-spatter composition; however, this is not required. In one non-limiting embodiment, the amount of water in the anti-spatter composition is generally greater than the Lecithin and/or surfactant content in the anti-spatter composition. The volume or weight ratio of Lecithin to water is generally 1:1.1-99, typically 1:2-90, more typically 1:2-50, still more typically 1:2-20, yet more typically 1:2-15, still yet more typically 1:2-10, still more typically 1:3-8, and further more typically 1:4-8. The volume or weight ratio of organic solvent to water is generally 1:0.1-99, typically 1:0.2-90, more typically 1:0.5-50, still more typically 1:1-20, yet more typically 1:1.01-15, still yet more typically 1:2-10, still more typically 1:3-8, and further more typically 1:4-8. In one non-limiting embodiment, the volume or weight percent of organic solvent is less than the volume or weight percent of water in the anti-spatter composition. The volume or weight ratio of surfactant to water is generally 1:5-150, typically 1:10-120, more typically 1:20-110, still more typically 1:25-100, and yet more typically 1:30-90. The volume or weight ratio of surfactant to organic solvent is generally 1:2-150, typically 1:5-120, more typically 1:10-100, still more typically 1:15-95, and yet more typically 1:20-90. The volume or weight ratio of surfactant to Lecithin is generally 1:1.01-50, typically 1:1.5-40, more typically 1:2-30, still more typically 1:4-20, and yet more typically 1:5-10.

One or more additional components can optionally be added to the anti-spatter composition of the present invention. Non-limiting additives include emulsifier, thickening agent, stabilizing agent, and the like.

It is one non-limiting object of the present invention to provide an improved anti-spattering agent.

It is another one non-limiting object of the present invention to provide an improved anti-spattering agent for the laser cutting of metal materials.

It is still another one non-limiting object of the present invention to provide an improved anti-spattering agent for the laser cutting of titanium and titanium containing materials.

It is yet another one non-limiting object of the present invention to provide an improved anti-spattering agent that is absent or substantially absent (e.g., less than 0.1 weight percent) halogen containing compounds.

It is still yet another one non-limiting object of the present invention to provide an improved anti-spattering agent that includes organic solvent that does not contain halogen or halogen compounds and Lecithin

It is another one non-limiting object of the present invention to provide an improved anti-spattering agent that includes organic solvent that does not contain halogen or halogen compounds, Lecithin, water and surfactant.

It is still another one non-limiting object of the present invention to provide an improved anti-spattering agent that includes organic solvent that does not contain halogen or halogen compounds, Lecithin, water and surfactant, and wherein the surfactant includes trisodium phosphate (TSP) and/or TSP substitutes.

These and other objects and advantages will become apparent from the following description.

### DETAILED DESCRIPTION OF NON-LIMITING EMBODIMENTS

The present invention pertains to an improved anti-spatter composition that is particularly advantageous for use in the laser cutting titanium and titanium alloys. The improved anti-spatter composition includes an organic solvent that does not contain halogen or halogen compounds and Lecithin. The improved anti-spatter composition is generally halogen free or substantially halogen free (i.e., less than about 0.5 weight percent halogen, less than about 0.4 weight percent halogen, less than about 0.3 weight percent halogen, less than about 0.2 weight percent halogen, less than about 0.1 weight percent halogen, less than about 0.05 weight percent halogen, less than about 0.01 weight percent halogen, etc.). The improved anti-spatter composition of the present invention 1) reduces spatter during the laser cutting of titanium containing materials, 2) can be easily applied to the surface of titanium containing materials, 3) remains on the titanium containing materials prior to and during the laser cutting process, 4) is easy to clean from the cut titanium containing materials, and/or 5) inhibits or prevents spatter from re-solidifying on the cut titanium containing materials. In one non-limiting formulation, the organic solvent is or includes Isopropyl Alcohol. Generally, the volume or weight percent of Lecithin is less than the volume or weight percent of organic solvent in the anti-spatter composition. For example, the volume or weight ratio of Lecithin to organic solvent is generally 1:3-12, typically 5-9:1, and more typically 1:6-8.

The anti-spatter composition can optionally include water and a surfactant. Generally, the water and surfactant are absent or substantially absent halogens. The water is generally deionized water; however, this is not required. The surfactant is also generally halogen free so as to eliminate the introduction of halogens into the anti-spatter composition; however, this is not required. Non-limiting surfactant that can be used include trisodium phosphate (TSP) and/or TSP substitutes (i.e., phosphate free surfactant). When water and surfactant are included in the anti-spatter composition, the amount of water and the amount of organic solvent are generally greater than the Lecithin and/or surfactant content in the anti-spatter composition.

Non-limiting formulations of the anti-spatter composition of the present invention are as follows:

| Component | Ex. A | Ex. B | Ex. C | Ex. D | Ex. E |
|---|---|---|---|---|---|
| Lecithin | 1-99% | 5-95% | 5-50% | 5-40% | 5-30% |
| Organic solvent | 1-99% | 5-95% | 50-95% | 60-95% | 70-95% |
| Component | Ex. F | Ex. G | Ex. H | Ex. I | Ex. J |
| Lecithin | 5-20% | 6-20% | 7-20% | 8-20% | 10-20 |
| Organic solvent | 80-95% | 80-94% | 80-93% | 80-92% | 80-90% |
| Component | Ex. K | Ex. L | Ex. M | Ex. N | Ex. 0 |
| Lecithin | 0.1-75% | 0.5-70% | 1-65% | 1.5-60% | 2-55% |
| Organic solvent | 1-80% | 5-75% | 10-70% | 12-65% | 14-62% |
| Water | 1-80% | 5-75% | 10-70% | 12-65% | 14-62% |
| Surfactant | 0.01-30% | 0.05-25% | 0.075-22% | 0.1-20% | 0.2-18% |
| Component | Ex. P | Ex. Q | Ex. R | Ex. S | Ex. T |
| Lecithin | 2.5-40% | 3-30% | 3.5-25% | 4-20% | 5-15% |
| Organic solvent | 15-60% | 20-55% | 25-50% | 30-48% | 35-45% |
| Water | 15-60% | 20-55% | 25-50% | 30-48% | 35-45% |
| Surfactant | 0.25-10% | 0.3-8% | 0.35-5% | 0.4-2% | 0.5-1% |
| Component | Ex. U | Ex. V | Ex. W | Ex. X | Ex. Y |
| Lecithin | 8-15% | 7-12% | 7-11% | 6-9% | 10-18% |
| Isopropyl | 75-93% | 72-85% | 62-78% | 55-70% | 72-90% |
| Alcohol (70%) | | | | | |
| Deionized Water | 0% | 2-10% | 5-20% | 5-30% | 0% |
| Surfactant | 0% | 0.1-5% | 0.1-6% | 0.1-7% | 0% |

| Component | Ex. Z |
|---|---|
| Lecithin | 10-14% |
| Isopropyl | 70-80% |
| Alcohol (70%) | |
| Deionized Water | 1-9.9% |
| Surfactant | 0.01-3% |

It has been found that the organic solvent breaks down the Lecithin so that a thin layer of anti-spatter composition can be applied to the metal material by use of a traditional sprayer. As can be appreciated, the anti-spatter composition can be applied to the metal material by other means (e.g., aerosol application, pour on application, etc.). The Lecithin in the anti-spatter composition is believed to inhibit or prevent spatter and to promote adhesion of the anti-spatter composition to the metal surface to be cut. The organic solvent (e.g., Isopropyl alcohol, Methyl alcohol, Ethyl alcohol, acetone, Stoddard agent, mineral spirits, etc.) is believed to function as a dispersing agent to improve the separation of particles, in this case the lecithin, by reducing the interfacial tension between the organic solvent and the lecithin.

One or more additional components can optionally be added to the anti-spatter composition of the present invention. Non-limiting additives include emulsifier, thickening agent, stabilizing agent, and the like.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

1-15. (canceled)

16. A method for laser cutting metal and reducing spatter during the cutting process comprising:
a. providing a metal material; and,
b. applying an anti-spatter composition to said metal material during laser cutting of said metal material, said anti-spatter composition comprising Lecithin and organic solvent, said organic solvent absent halogen and halogen containing compound.

17. The method as defined in claim 16, wherein said metal material includes titanium.

18. The method as defined in claim 16, wherein said anti-spatter composition includes water and surfactant, said Lecithin present in a greater weight percentage than said surfactant, a combined weight of said water and organic solvent constituting over 50 weight percent of said anti-spatter composition.

19. The method as defined in claim 18, wherein said surfactant is halogen free.

20. The method as defined in claim 18, wherein said surfactant includes one or more compounds selected from the group consisting of trisodium phosphate (TSP) and TSP substitutes.

21. The method as defined in claim 18, wherein said water is deionized water.

22. The method as defined in claim 16, wherein said anti-spatter composition comprising by weight percent:
Lecithin 5-40%
Organic solvent 60-95%.

23. The method as defined in claim 16, wherein said anti-spatter composition comprising by weight percent:
Lecithin 5-30%
Organic solvent 70-95%.

24. The method as defined in claim 16, wherein said anti-spatter composition comprising by weight percent:
Lecithin 5-20%
Organic solvent 80-95%.

25. The method as defined in claim 16, wherein said anti-spatter composition comprising by weight percent:
Lecithin 10-20%
Organic solvent 60-90%.

26. The method as defined in claim 16, wherein said anti-spatter composition comprising by weight percent:
Lecithin 0.1-75%
Organic solvent 1-80%.
Water 1-80%
Surfactant 0.01-30%.

27. The method as defined in claim 16, wherein said anti-spatter composition comprising by weight percent:
Lecithin 1.5-60%
Organic solvent 12-65%.
Water 12-65%
Surfactant 0.1-20%.

28. The method as defined in claim 16, wherein said anti-spatter composition comprising by weight percent:
Lecithin 2.5-40%
Organic solvent 15-60%.
Water 15-60%
Surfactant 0.25-10%.

29. The method as defined in claim 16, wherein said anti-spatter composition comprising by weight percent:
Lecithin 5-15%
Organic solvent 35-45%.
Water 35-45%
Surfactant 0.5-1%.
